(19) United States
(12) Patent Application Publication
(10) Pub. No.: US 2026/0316680 A1
(43) Pub. Date: Oct. 15, 2026

(54) VEHICULAR HEAD-UP DISPLAY SYSTEM WITH REARWARD VIEWS

(71) Applicant: Magna Mirrors of America, Inc., Holland, MI (US)

(72) Inventor: Michael J. Baur, Kentwood, MI (US)

(21) Appl. No.: 19/467,948

(22) Filed: Feb. 3, 2026

Related U.S. Application Data
(60) Provisional application No. 63/756,865, filed on Feb. 11, 2025.

(51) Int. Cl. B60R 1/26; B60K 35/23; B60K 35/65; B60R 1/24; B60R 1/25; H04N 7/18

(52) U.S. Cl. CPC B60R 1/26; B60K 35/23; B60K 35/654; B60R 1/24; B60R 1/25; H04N 7/183; B60K 2360/176; B60K 2360/21; B60R 2300/105; B60R 2300/202; B60R 2300/205; B60R 2300/802

(57) ABSTRACT

A vehicular driving assist system includes a rearward viewing camera disposed at a vehicle that views exterior and at least rearward of the vehicle. A head-up display system is disposed at the vehicle and is configured to display one or more visual elements in a field of view of a driver of the vehicle while the driver views forward of the vehicle through a windshield. The system, via processing of image data captured by the rearward viewing camera, displays rearward video images via the head-up display system and the displayed rearward video images are viewable by the driver while the driver views forward of the vehicle through the windshield. The reward video images are representative of a rearward view of the driver that is exterior the vehicle and at least rearward of the vehicle.

### CROSS REFERENCE TO RELATED APPLICATION

The present application claims the filing benefits of U.S. provisional application Ser. No. 63/756,865, filed Feb. 11, 2025, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A driving assistance system or vision system or imaging system for a vehicle utilizes one or more cameras (preferably one or more CMOS cameras) to capture image data representative of images exterior of the vehicle, and provides a head-up display (HUD) at or near a windshield of the vehicle that includes video images representative of a rearward view of the driver. The HUD may replace or enhance the view provided to the driver by an interior rearview mirror assembly.

For example, a rearward viewing camera is disposed at a vehicle equipped with the vehicular driving assist system, and the rearward viewing camera views exterior the vehicle and at least rearward of the vehicle. Image data captured by the rearward viewing camera is transferred to an electronic control unit (ECU). The ECU includes electronic circuitry and associated software, and the electronic circuitry of the ECU includes an image processor operable to process image data transferred to the ECU. A head-up display system is disposed at the vehicle. The head-up display system is configured to display one or more visual elements in a field of view of a driver of the vehicle while the driver views forward of the vehicle through a windshield of the vehicle. The vehicular driving assist system, via processing at the ECU of image data captured by the rearward viewing camera, displays interior rearview mirror video images via the head-up display system. When the head-up display system displays the interior rearview mirror video images, and when the driver views forward of the vehicle through the windshield of the vehicle, the interior rearview mirror video images are viewable by the driver at or near the windshield of the vehicle. The interior rearview mirror video images are representative of a rearward view of the driver of the vehicle that is exterior the vehicle and at least rearward of the vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a schematic view of the windshield of the vehicle with a head-up display (HUD) projected onto an interior side of the windshield;

FIG. 3 is a plan view of the vehicle with an A-pillar display device;

FIG. 3A is a perspective view of the A-pillar display device within the interior cabin of the vehicle at section A of FIG. 3; and

FIGS. 4 and 5 are schematic views of an interior cabin of the vehicle with A-pillar blind spot images and exterior rearview mirror images displayed at or near the A-pillar of the vehicle.

### DESCRIPTION OF THE PREFERRED EMBODIMENTS

Traditionally, the automotive industry has relied on reflective mirrors to provide visual surveillance of areas blocked from direct observation to a driver of a vehicle. In most cases, this has resulted in two outside mirrors (one on each side of the vehicle) and a single inside mirror. The specific requirements for these mirrors are contained in regulations in various parts of the world. With the advent of cameras and displays, some regions of the world have not allowed for the replacement of mirrors with cameras and displays. In addition, the use of head-up displays (HUDs) have enhanced the ability of the driver to maintain focus on the environment around them.

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction and/or provide enhanced views exterior of the vehicle to the driver of the vehicle. The vision system includes an image processor or image processing system that is operable to receive image data from one or more cameras and provide an output to a display device for displaying images representative of the captured image data.

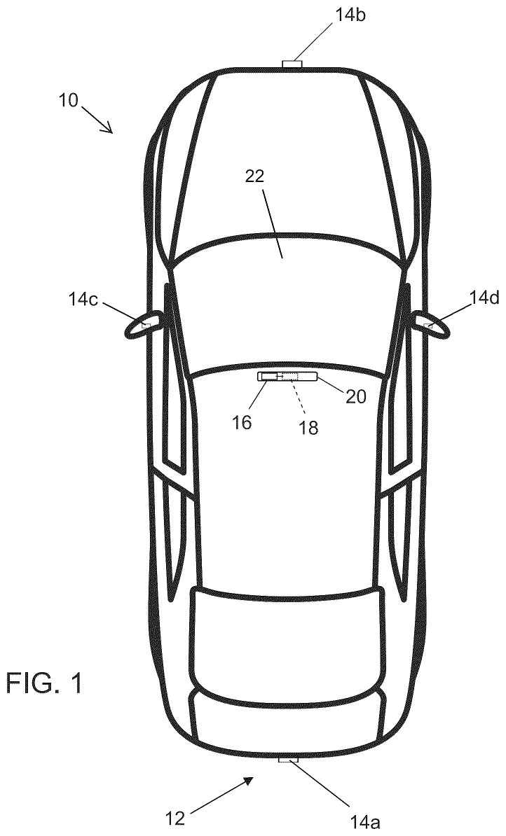

Referring now to the drawings and the illustrative embodiments depicted therein, a vehicle 10 includes an imaging system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 16 having electronic circuitry and associated software, with the electronic circuitry including a data processor or image processor that is operable to process image data captured by the camera or cameras, whereby the ECU may detect or determine presence of objects or the like and/or the system provide displayed images at a display device for viewing by the driver of the vehicle. The data transfer or signal communication from the camera to the ECU may comprise any suitable data or communication link, such as a vehicle network bus or the like of the equipped vehicle.

The vehicle 10 may also be equipped with a driver monitoring system (DMS) which tracks the driver's eye and head position, calculating a driver's gaze or the vector at which they are looking. The DMS includes a driver monitoring camera 18 disposed at an interior portion of the vehicle and having a field of view that includes at least a head region of a driver of the vehicle. The DMS camera 18 may be utilized to monitor the driver of the vehicle (such as for safety systems of the vehicle), to provide video calling capabilities, or for any suitable function. By processing image data captured by the DMS camera 18 at the ECU 16, the vision system 12 may be capable of tracking the driver's eye and head movements to determine, for example, a gaze direction of the driver, whether the driver is looking at the road (and optionally where the driver is looking on the road), whether the driver is viewing one of the rearview mirrors of the vehicle, an attention level of the driver, and/or whether the driver is looking elsewhere in the interior of the vehicle or exterior the vehicle. Furthermore, by processing the image data captured by the DMS camera 18, the system 12 may determine whether the gaze direction of the driver is toward a blind spot region (and optionally where in the blind spot region the driver is attempting to view). Although shown as disposed at an overhead console module 20 of the vehicle, the DMS camera 18 and/or the ECU 16 of the vision system 12 may be disposed elsewhere in the vehicle, such as at a center console or dashboard of the vehicle.

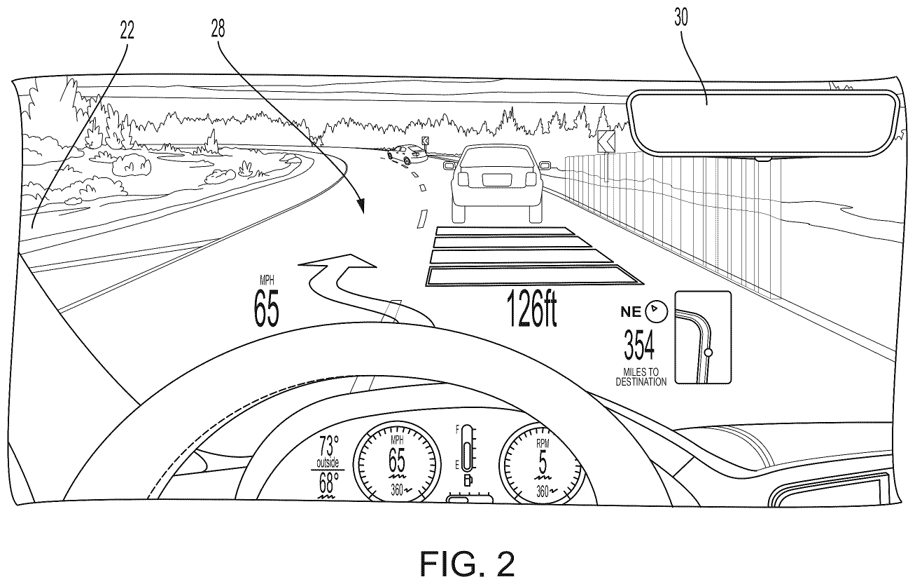

The vehicle 10 includes a head-up display (HUD) system that operates to project light toward the windshield 22 of the vehicle 10 to display an image or display or graphic overlay 24 for viewing by the driver of the vehicle (FIG. 2). For example, one or more light projectors for projecting the HUD display 24 onto the windshield (or optionally onto a transparent substrate at or near the windshield) may be disposed at the dashboard of the vehicle, at the headliner of the vehicle, or in any suitable position for projecting images onto the interior surface of the windshield 22. The graphic overlay 24 may include one or more icons configured to relay information to the driver of the vehicle, such as a current speed of the vehicle, navigation information or directions or a map, arrows or other indicators related to a direction of travel of the vehicle, and the like. Further, information or images displayed as part of the graphic overlay 24 may be based on objects, pedestrians, and other vehicles in the environment. For example, the graphic overlay 24 may include one or more icons indicative of a lane marking, a distance between the equipped vehicle and a leading vehicle ahead of the equipped vehicle in the same lane of travel, and the like. The HUD system may cooperate with the DMS to position displayed graphics at the windshield 22 relative to the objects, pedestrians, and other vehicles viewed by the driver through the windshield 22. Optionally, the head-up display 24 covers the entire field of view of the driver (e.g., extends across a majority or entirety of the windshield 22 of the vehicle and/or one or more windows of the vehicle). In some examples, augmented reality (AR) functions may be added. This allows the system to provide the driver more information directly within the driving field than is otherwise normally available to the driver. The HUD system may utilize characteristics of the driving assist systems described in U.S. Pat. Nos. 11,072,286; 10,664,115; 10,401,621; 10,324,297 and/or 10,139,978 and/or U.S. Publication Nos. US-2024-0119873, which are hereby incorporated herein by reference in their entireties.

As shown in FIG. 2, the HUD display 24 may include a rearview image portion 30 where video images representative of a view rearward of the vehicle 10 may be displayed at or near the windshield 22. In other words, image data captured by one or more cameras of the vehicle 10 (e.g., the rearward viewing camera 14a) is processed to generate video images for viewing by the driver of the vehicle as part of the HUD display 24. In the illustrated example, the rearview image portion 30 of the HUD display 24 displays video images representative of the rearward view provided by the reflections of a traditional interior rearview mirror assembly. The rearview image portion 30 may be displayed at or near a portion of the windshield 22 corresponding to a position of a traditional interior rearview mirror (e.g., at an upper central portion of the windshield 22) or at any suitable portion of the windshield 22 (e.g., at a lower central portion of the windshield, at a lower driver side portion of the windshield, and the like). For example, a transparent substrate may extend from a headliner of the vehicle at or near an upper central portion of the windshield 22 with the video images projected on to the substrate to provide the rearview image portion 30 of the HUD display 24. Further, the display of the rearview image portion 30 may appear like or mimic an interior rearview mirror. For example, the shape or outline of the rearview images may correspond to the shape or outline of a mirror reflective element of an interior rearview mirror.

The video images may be adjusted or moved to represent the rearward view of the driver based on, for example, a seating position of the driver relative to the position of the rearview image portion 30 at the windshield 22, the viewing angle or gaze direction of the driver (e.g., as determined by the DMS), and the like. In other words, based on movement of the driver's head and/or gaze direction and/or based on a seating position of the driver, the video images displayed at the rearview image portion 30 may be adjusted, such as to adjust the portion of the image data captured by the rearward viewing camera that is shown in the displayed video images. The display may utilize characteristics of the video mirror systems described in U.S. Pat. Nos. 10,442,360; 10,421,404; 10,166,924 and/or 10,046,706, and/or U.S. Publication Nos. US-2021-0323473; US-2021-0245662; US-2021-0162926; US-2021-0155167; US-2021-0094473; US-2020-0377022; US-2019-0258131; US-2019-0146297; US-2019-0118717; US-2019-0047475 and/or US-2017-0355312, which are all hereby incorporated herein by reference in their entireties.

Video images may be displayed at the rearview image portion 30 of the HUD display 24 throughout operation of the vehicle, such that the rearview image portion 30 may replace or reduce the need for a traditional, physical interior rearview mirror at the vehicle. Optionally, the vehicle may include an interior rearview mirror assembly and the rearview image portion 30 of the HUD display 24 may be activated based on a driver input. For example, based on determination that the driver is viewing a portion of the windshield 22 at or near or corresponding to the rearview image portion 30 (e.g., an upper central portion of the windshield), the system may begin displaying the rearward view video images at the rearview image portion 30. In some examples, the rearview image portion 30 may be activated and/or deactivated based on a user input (e.g., a button in the interior cabin of the vehicle and/or at an infotainment system of the vehicle) and/or based on a driving condition of the vehicle (e.g., based on the vehicle operating in an autonomous driving mode or a manual driving mode).

Optionally, the system may enhance or adjust the displayed video images at the rearview image portion 30. For example, based on determination that the driver is looking at or near the rearview image portion 30, the HUD system may enlarge the displayed video images. In other words, the video images may account for a larger portion of the HUD display 24 at the windshield 22 when the driver is viewing them than when the driver is looking away (e.g., looking through the windshield in front of the vehicle). In some examples, the system may highlight or apply a graphic overlay at a detected object in the video images displayed at the rearview image portion 30.

In other words, by projecting the image from the rearview camera into a position typically occupied by the rearview mirror, a simplification can be made to the forward cabin area of the vehicle. In addition to the dynamic image rendered to replace the rearview mirror, other enhancements can be added to the area around the display including some elements of AR depending on the size of the projection. Adding the rearview image to the AR HUD display 24 may fully integrate the systems from a hardware and software perspective.

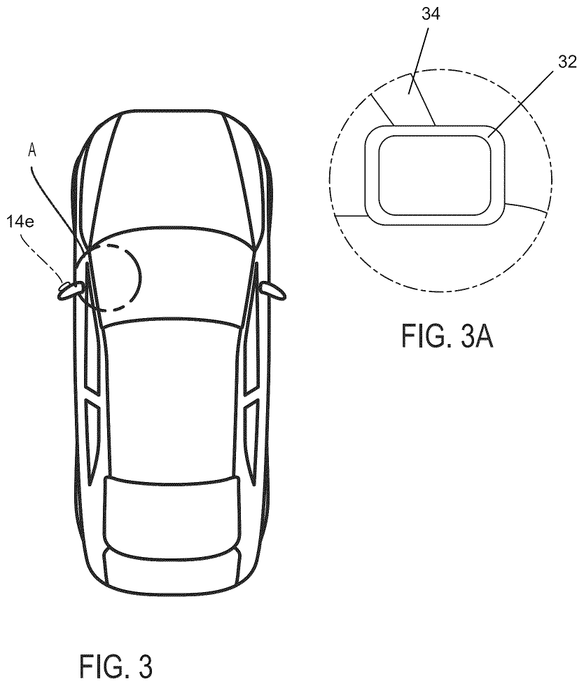

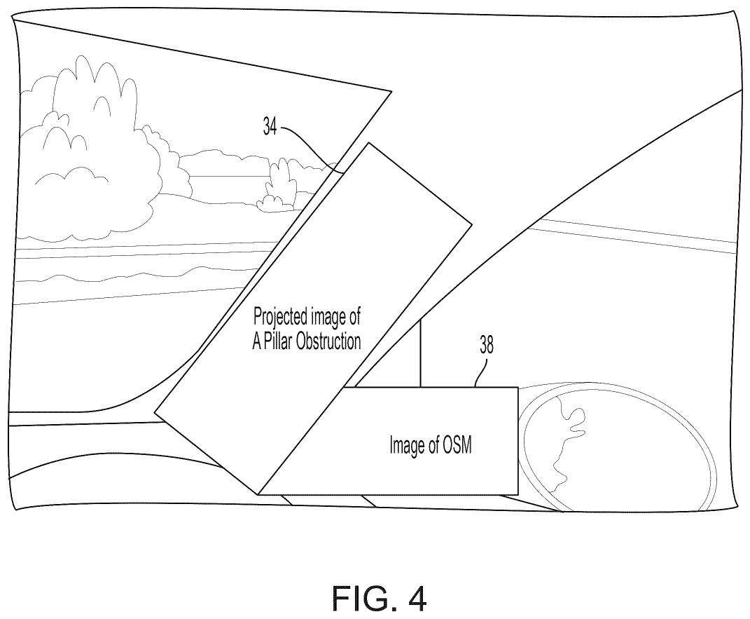

Referring to FIGS. 3 and 3A, the vehicle 10 may further include a sideward/forward viewing imaging sensor or camera 14e at the driver side of the vehicle 10 (such as at an exterior rearview mirror position) and viewing at least sideward and forward of the vehicle 10. Image data captured by the camera 14e may be processed to generate A-pillar blind spot video images for displaying at an A-pillar display device 32 disposed at an A-pillar 34 of the vehicle 10. The vehicle 10 may also include a sideward/forward viewing imaging sensor or camera at the passenger side of the vehicle 10 for generating video images for display at an A-pillar display device at the passenger side A-pillar of the vehicle 10.

In other words, the vehicle 10 is equipped with a “see-through” A-pillar display system, which utilizes the camera to capture what is behind the A-pillar 34 of the vehicle 10, aimed outside the vehicle 10 in line with the driver's sight. The A-pillar 34 of the vehicle 10 obstructs at least a portion of a driver's view when the driver views forward and sideward of the vehicle 10 when driving the vehicle 10 (i.e., when seated in a driver's seat of the vehicle) and these obstructed portions of the driver's view are known as the A-pillar blind spots. Video images derived from image data captured by the camera and representing a view of at least a portion of one or both of the A-pillar blind spots are displayed on the A-pillar 34 via the A-pillar display device 32, which may comprise, for example, a curved display at an interior surface of the A-pillar 34 or a projected display that projects video images onto the interior surface of the A-pillar 34 from a remote location. The images displayed at the A-pillar display device 32, when viewed by a driver of the vehicle, reduce or eliminate the A-pillar blind spot. The A-pillar display device 32 may utilize aspects described in U.S. Pat. No. 10,960,822 and/or U.S. Publication No. US-2022-0363194, which are hereby incorporated herein by reference in their entireties.

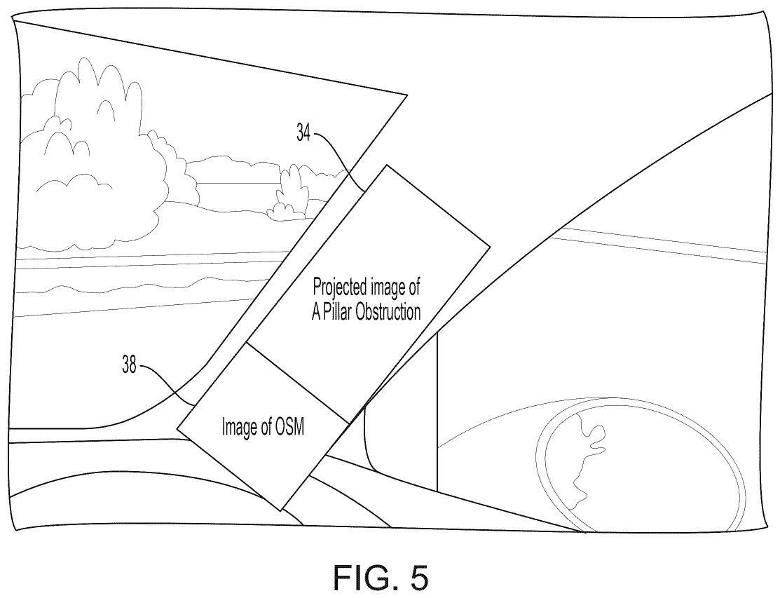

In some examples, the HUD system may operate to project A-pillar video images onto an interior surface at or near the A-pillar 34 of the vehicle 10. For example, and as shown in FIGS. 4 and 5, the HUD system may project the video images onto the A-pillar 34 (e.g., onto an opaque glass panel at the A-pillar) and/or onto a portion of the windshield 22 near the A-pillar 34 and/or onto a portion of the window 36 (e.g., the window at the driver side door or the passenger side door) near the A-pillar 34.

Video images may be displayed at or near the A-pillar 34 throughout operation of the vehicle. Optionally, the displayed images at the A-pillar 34 may be activated based on a driver input. For example, based on determination that the driver is viewing a portion of the windshield 22 at or near or corresponding to the displayed A-pillar images (e.g., a driver side portion of the windshield or a passenger side portion of the windshield) or based on determination that the driver is viewing an exterior rearview mirror of the vehicle or viewing through the side window of the vehicle, the system may begin displaying the video images at the A-pillar 34 of the vehicle to provide a substantially continuous view spanning the windshield, A-pillar, and side window of the vehicle. In some examples, the images at or near the A-pillar 34 may be activated and/or deactivated based on a user input (e.g., a button in the interior cabin of the vehicle and/or at an infotainment system of the vehicle) and/or based on a driving condition of the vehicle (e.g., based on the vehicle operating in an autonomous driving mode or a manual driving mode, or during performance of a parking maneuver).

Optionally, the system may enhance or adjust the displayed video images at the A-pillar 34. For example, based on determination that the driver is looking at or near the A-pillar 34, the system may enlarge the displayed video images or the system may highlight or apply a graphic overlay at a detected object in the video images displayed at the A-pillar 34.

Further, the HUD system may operate to project exterior rearview video images 38 representative of the rearward view along the side of the vehicle provided by the reflections of a traditional exterior rearview mirror assembly. The exterior rearview video images 38 may be displayed at a portion of the windshield 22 near the A-pillar 34, at a portion of the A-pillar 34 or A-pillar display device 32, and/or at a portion of the side window 36 of the vehicle 10. When the A-pillar blind spot images and the exterior rearview video images 38 are both displayed at the A-pillar 34, the A-pillar blind spot images may be disposed above the exterior rearview video images 38 (as shown in FIG. 5) or the A-pillar blind spot images may be disposed below the exterior rearview video images 38. The video images displayed at the A-pillar display device 32 and the exterior rearview video images 38 may be adjusted based on the determined head position and/or gaze direction of the driver (e.g., as determined by the DMS). Further, the displayed video images may be activated and/or enhanced responsive to determining that the driver is looking toward the A-pillar and/or exterior rearview mirror position of the vehicle. The exterior rearview mirror display may utilize aspects of the vehicle vision systems described in U.S. Publication Nos. US-2025-0115215; US-2024-0190350 and/or US-2023-0211740, which are hereby incorporated herein by reference in their entireties.

The exterior rearview video images 38 may be displayed throughout operation of the vehicle, such that the exterior rearview video images 38 may replace or reduce the need for a traditional, physical exterior rearview mirror at the vehicle. Optionally, the vehicle may include an exterior rearview mirror assembly and the exterior rearview video images 38 may be activated based on a driver input. For example, based on determination that the driver is viewing a portion of the A-pillar 34 at or near or corresponding to the exterior rearview video images 38 (e.g., a lower portion of the A-pillar) or a portion of the side window at or near or corresponding to the exterior rearview mirror, the system may begin displaying the exterior rearview video images 38. In some examples, the exterior rearview video images 38 may be activated and/or deactivated based on a user input (e.g., a button in the interior cabin of the vehicle and/or at an infotainment system of the vehicle) and/or based on a driving condition of the vehicle (e.g., based on the vehicle operating in an autonomous driving mode or a manual driving mode or during a parking maneuver or a reversing maneuver).

Optionally, the system may enhance or adjust the displayed exterior rearview video images 38. For example, based on determination that the driver is looking at or near the exterior rearview video images 38, the HUD system may enlarge the displayed video images. In other words, the exterior rearview video images 38 may account for a larger portion of the A-pillar display when the driver is viewing the A-pillar 34 than when the driver is looking away (e.g., looking through the windshield in front of the vehicle). This may be adjusted based on whether the driver is viewing the A-pillar video images or the exterior rearview video images 38, such that the A-pillar video images are enlarged compared to the exterior rearview video images 38 when the driver is viewing the A-pillar video images. In some examples, the system may highlight or apply a graphic overlay at a detected object in the video images displayed at the A-pillar 34.

In other words, the A-pillar construction of modern vehicles has increased the blind spot associated with the actual structure of the A-pillar. By incorporating a similar approach as the rearview image portion 30 of the HUD display 24, a sideview or A-pillar blind spot image may be projected onto the door glass and/or an opaque panel (e.g., placed in a corner region of the vehicle dashboard area between the bottom sill of the door glass and the A-pillar). With proper configuration and the additional cameras, the projection may include a projection onto an opaque A-pillar. In this case, the image may be split between a rearview outside mirror (OSM) image and an image that appears to peer through the A-pillar, thus eliminating or reducing the A-pillar blind spot. One or both of these projections may include AR content to alarm and alert the driver to previously unseen conditions. To minimize obstructions to the driver's view, the OSM image may be displayed on the bottom of the A-pillar image.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or International Publication Nos. WO 2023/220222; WO 2025/231198 and/or WO 2026/019985, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at the A-pillar display device or as part of the HUD display or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a rearward viewing camera disposed at a vehicle equipped with the vehicular driving assist system, wherein the rearward viewing camera views exterior the vehicle and at least rearward of the vehicle;
an electronic control unit (ECU);
wherein image data captured by the rearward viewing camera is transferred to the ECU;
wherein the ECU comprises electronic circuitry and associated software, and wherein the electronic circuitry of the ECU comprises a processor operable to process image data captured by the rearward viewing camera and transferred to the ECU;
a head-up display system disposed at the vehicle, wherein the head-up display system is configured to display one or more visual elements within a field of view of a driver of the vehicle while the driver views forward of the vehicle through a windshield of the vehicle;
wherein the vehicular driving assist system, via processing at the ECU of image data captured by the rearward viewing camera, displays rearward video images via the head-up display system;
wherein, when the head-up display system displays the rearward video images, and when the driver views forward of the vehicle through the windshield of the vehicle, the displayed rearward video images are viewable by the driver while the driver views forward of the vehicle through the windshield of the vehicle; and
wherein the rearward video images are representative of a rearward view of the driver of the vehicle that is exterior the vehicle and at least rearward of the vehicle.

2. The vehicular driving assist system of claim 1, wherein a blind spot camera is disposed at the vehicle, and wherein the blind spot camera at least partially views an A-pillar blind spot region forward and sideward of the vehicle, and wherein the A-pillar blind spot region is at least in part caused by an A-pillar of the vehicle at least partially blocking a view of the driver when the driver views forward and sideward of the vehicle, and wherein the vehicular driving assist system, via processing at the ECU of image data captured by the blind spot camera, displays A-pillar blind spot video images, and wherein the A-pillar blind spot video images are representative of the A-pillar blind spot region forward and sideward of the vehicle.

3. The vehicular driving assist system of claim 2, wherein the A-pillar blind spot video images are displayed at an A-pillar display device disposed at the A-pillar of the vehicle.

4. The vehicular driving assist system of claim 2, wherein the A-pillar blind spot video images are projected at an interior surface of the vehicle at the A-pillar of the vehicle.

5. The vehicular driving assist system of claim 2, wherein the A-pillar blind spot video images are projected at a region of the windshield that is at or near the A-pillar of the vehicle.

6. The vehicular driving assist system of claim 2, wherein the A-pillar blind spot video images are projected at a region of a window at a door of the vehicle at or near the A-pillar of the vehicle.

7. The vehicular driving assist system of claim 1, wherein a rearward and sideward viewing camera is disposed at a side of the vehicle, and wherein the rearward and sideward viewing camera views at least rearward of the vehicle at the side of the vehicle, and wherein the vehicular driving assist system, via processing at the ECU of image data captured by the rearward and sideward viewing camera, displays sideward video images, and wherein the sideward video images are representative of a rearward and sideward view that is exterior the vehicle and at least rearward of the vehicle at the side of the vehicle.

8. The vehicular driving assist system of claim 7, wherein the sideward video images are displayed at an A-pillar display device disposed at an A-pillar of the vehicle at the side of the vehicle.

9. The vehicular driving assist system of claim 7, wherein the sideward video images are projected at an interior surface of the vehicle at an A-pillar of the vehicle at the side of the vehicle.

10. The vehicular driving assist system of claim 7, wherein the sideward video images are displayed by the head-up display system so as to be viewable by the driver at a region of the windshield at or near the side of the vehicle.

11. The vehicular driving assist system of claim 7, wherein the sideward video images are displayed so as to be viewable at a region of a window at a door of the vehicle at the side of the vehicle.

12. The vehicular driving assist system of claim 1, wherein the displayed rearward video images are viewable by the driver at an upper central region of the windshield of the vehicle.

13. The vehicular driving assist system of claim 1, wherein the rearward video images are displayed as part of a representation of an interior rearview mirror reflective element.

14. The vehicular driving assist system of claim 1, wherein the rearward video images are displayed at least in part responsive to determination, via a driver monitoring system of the vehicle, that the driver of the vehicle is viewing a region of the windshield of the vehicle.

15. The vehicular driving assist system of claim 1, wherein, when the head-up display system displays the rearward video images to be viewable by the driver while the driver views forward of the vehicle through the windshield of the vehicle, and at least in part responsive to determination via a driver monitoring system of the vehicle that the driver of the vehicle is viewing the displayed rearward video images, the vehicular driving assist system enlarges display of the rearward video images.

16. The vehicular driving assist system of claim 1, wherein the head-up display system projects the rearward video images onto a surface to display the rearward video images viewable by the driver while the driver views forward of the vehicle through the windshield of the vehicle, and wherein the surface comprises one selected from the group consisting of (i) an in-cabin surface of the windshield of the vehicle and (ii) a surface of a substrate disposed at the windshield of the vehicle.

17. A vehicular driving assist system, the vehicular driving assist system comprising:
a rearward viewing camera disposed at a vehicle equipped with the vehicular driving assist system, wherein the rearward viewing camera views exterior the vehicle and at least rearward of the vehicle;
an electronic control unit (ECU);
wherein image data captured by the rearward viewing camera is transferred to the ECU;
wherein the ECU comprises electronic circuitry and associated software, and wherein the electronic circuitry of the ECU comprises a processor operable to process image data captured by the rearward viewing camera and transferred to the ECU;
a head-up display system disposed at the vehicle, wherein the head-up display system is configured to display one or more visual elements within a field of view of a driver of the vehicle while the driver views forward of the vehicle through a windshield of the vehicle;
wherein the vehicular driving assist system, via processing at the ECU of image data captured by the rearward viewing camera, displays rearward video images via the head-up display system;
wherein the rearward video images are displayed as part of a representation of an interior rearview mirror reflective element;
wherein, when the head-up display system displays the rearward video images, and when the driver views forward of the vehicle through the windshield of the vehicle, the rearward video images are projected onto an in-cabin surface of the windshield so as to be viewable by the driver at a region of the windshield of the vehicle;
wherein the rearward video images are displayed at least in part responsive to determination, via a driver monitoring system of the vehicle, that the driver of the vehicle is viewing the region of the windshield of the vehicle; and
wherein the rearward video images are representative of a rearward view of the driver of the vehicle that is exterior the vehicle and at least rearward of the vehicle.

18. The vehicular driving assist system of claim 17, wherein a rearward and sideward viewing camera is disposed at a side of the vehicle, and wherein the rearward and sideward viewing camera views at least rearward of the vehicle at the side of the vehicle, and wherein the vehicular driving assist system, via processing at the ECU of image data captured by the rearward and sideward viewing camera, displays sideward video images, and wherein the sideward video images are representative of a rearward and sideward view that is exterior the vehicle and at least rearward of the vehicle at the side of the vehicle.

19. A vehicular driving assist system, the vehicular driving assist system comprising:
a rearward viewing camera disposed at a vehicle equipped with the vehicular driving assist system, wherein the rearward viewing camera views exterior the vehicle and at least rearward of the vehicle;
an electronic control unit (ECU);
wherein image data captured by the rearward viewing camera is transferred to the ECU;
wherein the ECU comprises electronic circuitry and associated software, and wherein the electronic circuitry of the ECU comprises a processor operable to process image data captured by the rearward viewing camera and transferred to the ECU;
a head-up display system disposed at the vehicle, wherein the head-up display system is configured to display one or more visual elements within a field of view of a driver of the vehicle while the driver views forward of the vehicle through a windshield of the vehicle;
wherein the vehicular driving assist system, via processing at the ECU of image data captured by the rearward viewing camera, displays rearward video images via the head-up display system;
wherein the rearward video images are displayed as part of a representation of an interior rearview mirror reflective element;
wherein, when the head-up display system displays the rearward video images, and when the driver views forward of the vehicle through the windshield of the vehicle, the rearward video images are projected onto a surface of a substrate at the windshield so as to be viewable by the driver proximate an upper central region of the windshield of the vehicle; and
wherein the rearward video images are representative of a rearward view of the driver of the vehicle that is exterior the vehicle and at least rearward of the vehicle.

20. The vehicular driving assist system of claim 19, wherein a rearward and sideward viewing camera is disposed at a side of the vehicle, and wherein the rearward and sideward viewing camera views at least rearward of the vehicle at the side of the vehicle, and wherein the vehicular driving assist system, via processing at the ECU of image data captured by the rearward and sideward viewing camera, displays sideward video images, and wherein the sideward video images are representative of a rearward and sideward view that is exterior the vehicle and at least rearward of the vehicle at the side of the vehicle.
